(19) United States
(12) Patent Application Publication
(10) Pub. No.: US 2025/0043137 A1
(43) Pub. Date: Feb. 6, 2025

(54) COATINGS COMPRISING SALICYLATES

(71) Applicant: SWIMC LLC, Cleveland, OH (US)

(72) Inventor: Barry J. Tungland, Medina, OH (US)

(21) Appl. No.: 18/718,619

(22) PCT Filed: Dec. 8, 2022
(86) PCT No.: PCT/US2022/081130

§ 371 Date: Jun. 11, 2024

Related U.S. Application Data
(60) Provisional application No. 63/289,743, filed on Dec. 15, 2021.

(51) Int. Cl. C09D 7/63; C08K 5/134; C09D 7/48

(52) U.S. Cl. CPC C09D 7/63; C09D 7/48; C08K 5/1345

(57) ABSTRACT

The present application relates to a coating comprising at least one salicylate with at least 10 carbon atoms. At least one salicylate with at least 10 carbon atoms may comprise benzyl salicylate, octyl salicylate (2-ethyl hexyl salicylate), heptyl salicylate, hexyl salicylate, amyl salicylate, iso amyl salicylate, iso butyl salicylate, methyl salicylate, ethyl salicylate, or combinations thereof. Also described is a method of preparing the coating and an article containing the coating described herein.

### FIELD

The present disclosure relates generally to a coating comprising at least one salicylate with at least 10 carbon atoms. At least one salicylate may comprise benzyl salicylate, octyl salicylate (2-ethyl hexyl salicylate), heptyl salicylate, hexyl salicylate, amyl salicylate, isoamyl salicylate, iso butyl salicylate, methyl salicylate, ethyl salicylate, or combinations thereof. A method of preparing the coating and an article containing the coating are also disclosed.

### BACKGROUND

More recently, clearcoats, both waterborne and solvent borne, have been used in numerous applications, including but not limited to applications in automotive, aerospace, marine, general industrial, wood, plastics, electronics, and other consumer goods. However, these types of clear coatings struggle to meet the performance properties that pigmented coatings may achieve.

In addition, certain properties may improve with changes to formulations for both clearcoat and other coatings formulations while others may suffer due to these modifications. In particular, properties such as UV protection, lower VOC, and reduced or no odors, are difficult to achieve.

For example, both clearcoats and other coatings like paints, stains, varnishes, lacquers, drying oils, or powders, may provide UV protection for either a substrate or coatings underneath a coating. This UV protection may help coatings from fading and discoloring. Further, this UV protection may reduce changes in gloss and sheen, and UV protection may decrease over the life of a coating.

Additionally, current environmental demands, including requirements for lower or zero volatile organic compounds (VOC's), are difficult to achieve without sacrificing performance properties. For conventional coatings, increased regulations for coatings with lower VOC's have posed challenges for maintaining performance properties as well as other advantages.

Further, consumers are frequently demanding that any odors are reduced or eliminated with coatings both during application and drying. This is especially important if the coatings are applied in an indoor environment. Even if they are applied in an exterior environment, any unpleasant odors are undesirable.

Manufacturers and consumers, especially automotive, aerospace, marine, general industrial, wood, plastics, electronics, and other consumer goods manufacturers, have increasingly demanded for these particular performance requirements for coatings. Manufacturers and consumers are continually looking for coatings that exhibit these improved properties, such as improved weatherability, wear resistance, and adhesion while having a reduced or lower odor and decreased VOC's without sacrificing other performance properties. In view of these challenges with many conventional coatings, the need therefore remains for improved coatings having a binder that can provide weatherability, wear resistance, adhesion, weather resistance, gloss retention, lower VOC's, and other improved properties as well as other advantages.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A coating and methods of preparing are shown and described. The coating may comprise: relates to a coating comprising at least one salicylate with at least 10 carbon atoms. The coating may have at least one salicylate may comprise benzyl salicylate, octyl salicylate (2-ethyl hexyl salicylate), heptyl salicylate, hexyl salicylate, amyl salicylate, iso amyl salicylate, iso butyl salicylate, methyl salicylate, ethyl salicylate, or combinations thereof.

A method of making the coating comprising at least one salicylate with at least 10 carbon atoms is disclosed herein. An article containing the coating comprising at least one salicylate with at least 10 carbon atoms is also described.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### BRIEF DESCRIPTION OF THE DRAWINGS

The disclosure references the appended drawings. Advantages of embodiments of the present invention will be apparent from the following detailed description of the exemplary embodiments thereof, which description should be considered in conjunction with the accompanying drawings in which:

FIG. 1 illustrates an exemplary configuration of the mass loss in a coating for octyl salicylate compared to a control with ethylene glycol monobutyl ether acetate (referred to as EB acetate).

FIG. 2 illustrates another exemplary illustration of the evaporation rates in a coating for octyl salicylate compared to a control with ethylene glycol monobutyl ether acetate (referred to as EB acetate).

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings that provide advantageous improvements over current coatings. It has been discovered that the use of a particular coating comprising at least one salicylate with at least 10 carbon atoms can surprisingly lead to improved performance properties when used in a coating, namely weatherability, wear resistance, adhesion, weather resistance, gloss retention, lower VOC's as well as other advantages.

In many embodiments, a coating may comprise at least one salicylate with at least 10 carbon atoms. At least one salicylate may come from natural sources or produced synthetically. Salicylates are derived from salicylic acid. At least one salicylate with at least 10 carbon atoms may be liquid. However, salicylates with lower chain carbons, such as those with less than 10 carbon atoms, may be too volatile. In some embodiments, the coating described herein may comprise at least one salicylate with at least 11 carbon atoms. In another embodiment, the coating described herein may comprise at least one salicylate with at least 12 carbon atoms. In yet another embodiment, the coating described herein may comprise at least one salicylate with at least 13 carbon atoms. In some embodiments, the coating described herein may comprise at least one salicylate with at least 14 carbon atoms. In other embodiments, the coating described herein may comprise at least one salicylate with at least 15 carbon atoms. In yet other embodiments, the coating described herein may comprise at least one salicylate with at least 16 carbon atoms. In some embodiments, the coating described herein may comprise at least one salicylate with at least 17 carbon atoms. In another embodiment, the coating described herein may comprise at least one salicylate with at least 18 carbon atoms. In some embodiments, the coating described herein may comprise at least one salicylate with at least 19 carbon atoms. In other embodiments, the coating described herein may comprise at least one salicylate with at least 20 carbon atoms. In yet other embodiments, the coating described herein may comprise at least one salicylate with at least 21 carbon atoms. Salicylates with more than 22 carbon atoms are also contemplated. For example, methyl salicylate (wintergreen flavor) may be substantially liquid but too volatile, meaning that they evaporate at room conditions. However, some salicylates, often with higher carbon chains may be both substantially solid and non-volatile, often leading to challenges in incorporation into the coating as well as some coatings properties like viscosity increases and performance reductions. It has been found that certain salicylates that are substantially liquid may be useful in coatings. It has also been found that certain salicylates that are substantially non-volatile may be useful in coatings.

In many embodiments, the coating is a paint, stain, varnish, clearcoat, lacquer, drying oil, or powder. In many embodiments, the coating is a surface treatment, primer, intermediate coat, or topcoat. The coating described herein may show particular utility as clear coats, base coats, pigmented top coats, primers, and other coatings. In one embodiment, the coating is at least partially coated onto a base coat. The coating described herein is particularly suitable in the preparation of substrates, including but not limited to metal, plastics, wood, ceramics, cement, composites, or combinations thereof. The coating described herein may show particular utility as a monocoat, basecoat, primer, and clear coat, especially in the automotive coatings market for vehicles such as automobiles, trains, trucks, buses, and airplanes.

In some embodiments, the coating is solvent borne. In other embodiments, the coating is waterborne. In some embodiments, the coating comprising at least one salicylate with at least 10 carbon atoms is a 1K coating. In other embodiments, the coating comprising at least one salicylate with at least 10 carbon atoms is a 2K coating. Other types of coatings are also contemplated.

In many embodiments, at least one salicylate comprises benzyl salicylate, octyl salicylate (2-ethyl hexyl salicylate), heptyl salicylate, hexyl salicylate, amyl salicylate, iso amyl salicylate, iso butyl salicylate, methyl salicylate, ethyl salicylate, or combinations thereof. Other salicylates may also be contemplated. Additionally, at least one salicylate comprises salicylate derivatives. In some embodiments, salicylate derivatives may comprise magnesium salicylate, sodium salicylate, calcium salicylate, or combinations thereof. Further, at least one salicylate may comprise a salt of salicylic acid such as triethanolamine salt of salicylic acid.

In many embodiments, at least one salicylate with at least 10 carbon atoms may provide UV protection for a coating, helping to shield a substrate from harmful UV rays. For example, salicylates may act as a UV filter, especially as a UV-B filter, and provide improved weatherability for a coating.

Additionally, at least one salicylate with at least 10 carbon atoms may be used in coatings without observed significant effects on properties such as softness, dirt pickup, color change, chemical resistance, flexibility, surface appearance, and viscosity increases. Additional improved effects may also be seen with the coating comprising at least one salicylate with at least 10 carbon atoms.

In many embodiments, the coating comprising at least one salicylate with at least 10 carbon atoms may have the additional benefit of assisting in the subsequent flow and leveling of a coating, including post application and during the early film formation period, by helping to maintain a fluid and dynamic interface with the atmosphere, thus facilitating the diffusion of more volatile materials out of the film leaving behind a defect free surface with maximum appearance satisfaction. In many embodiments, the coating comprising at least one salicylate with at least 10 carbon atoms may have an improved appearance over a coating without at least one salicylate with at least 10 carbon atoms. In many embodiments, the coating comprising at least one salicylate with at least 10 carbon atoms has improved application properties over conventional coatings. Application may be spray, brush, roll, pad, or combinations thereof. Curing temperatures preferably are between 0 and 80° C. and more preferably between 1° and 60° C. Humidity conditions may range from 5% Relative Humidity to 95% Relative Humidity. Other application methods are also contemplated.

In many embodiments, the coating comprising at least one salicylate with at least 10 carbon atoms and described herein has a Volatile Organic Compound (VOC) as measured by ASTM D3960 of less than 4.2 lb./gallon (about 500 g/l). In other embodiments, the waterborne coating with the water-based binder described herein has a Volatile Organic Compound (VOC) as measured by ASTM D3960 of less than 2.8 lb./gallon (about 330 g/l). In some embodiments, the waterborne coating with the water-based binder described herein has a Volatile Organic Compound (VOC) as measured by ASTM D3960 of less than 2.1 lb./gallon (about 250 g/L). The VOC can, for example, be less than 1.5 lb./gallon (about 175 g/l), less than 1.25 lb./gallon (about 150 g/l), less than 1.1 1b./gallon (about 130 g/l), less than 1.0 lb./gallon (about 120 g/l), less than 0.75 lb./gallon (about 90 g/l), less than 0.5 lb./gallon (about 60 g/l), less than 0.4 lb./gallon (about 50 g/l), less than 0.3 lb./gallon (about 35 g/l), less than 0.2 lb./gallon (about 25 g/l), less than 0.1 lb./gallon (about 12 g/l), or less than 0.05 lb./gallon (about 5 g/l). Lower VOC values are also contemplated. In one embodiment, the waterborne coating with the water-based binder described herein has substantially no volatile organic compounds (VOC).

As described herein, VOC may be measured both neat on the benchtop as well as United States Environmental Protection Agency (EPA) Reference Method 24 (“EPA-24”) in actual coatings. EPA-24 may be carried out using ASTM D2369 in a mechanical oven. Although not bound by theory, at least one salicylate with at least 10 carbon atoms may also function as an inert plasticizer, thereby raising solids and lowering VOC. Further, salicylates with at least 10 carbon atoms may be an ester compound similar in composition to other volatile components used commonly in coatings, but the evaporation rate of a salicylate with at least 10 carbon atoms may be sufficiently lower while able to additionally lower or maintain the viscosity of polymers it is blended with. As a consequence, using at least one salicylate with at least 10 carbon atoms in a coating may improve certain application characteristics without raising the VOC's of the coating. In many embodiments, a coating with at least one salicylate with at least 10 carbon atoms may have an evaporation rate less than the threshold of a solid as defined by United States Environmental Protection Agency (EPA) Reference Method 24. Evaporation rate, as described herein, may alternatively be measured by ASTM 3539.

Additionally in some embodiments, at least one salicylate with at least 10 carbon atoms may potentially mask the unpleasant odor of certain materials in a coating, including but not limited to low molecular weight carboxylic acids. Examples of such materials contributing to unpleasant odors may include tertiary butyl acetate, parachlorobenzotrifluoride, and other volatile solvents. Additionally, certain resins may provide an unpleasant odor. Other materials contributing to unpleasant odors in coatings are also contemplated.

In some embodiments, the coating described herein comprises about 0.5% to about 7.0% by weight of at least one salicylate with at least 10 carbon atoms. In other embodiments, the at least one salicylate with at least 10 carbon atoms can, for example, range from about 0.5% about 0.5% to about 6.5%, about 0.5% to about 6.0%, about 0.5% to about 5.5%, about 0.5% to about 5.0%, about 0.5% to about 4.5%, about 0.5% to about 4.0%, about 0.5% to about 3.5%, about 0.5% to about 3.3%, about 0.5% to about 3.2%, about 0.5% to about 3.0%, about 0.6% to 7.0%, about 0.6% to about 6.5%, about 0.6% to about 6.0%, about 0.6% to about 5.5%, about 0.6% to about 5.0%, about 0.6% to about 4.5%, about 0.5% to about 4.0%, about 0.6% to about 3.3%, about 0.6% to about 3.0%, about 0.7% to 7.0%, about 0.7% to about 6.5%, about 0.7% to about 6.0%, about 0.7% to about 5.5%, about 0.7% to about 5.0%, about 0.7% to about 4.5%, about 0.7% to about 4.0%, about 0.7% to about 3.5%, about 0.7% to about 3.0%, about 0.7% to about 2.7%, about 0.8% to 7.0%, about 0.8% to about 6.5%, about 0.8% to about 6.0%, about 0.8% to about 5.5%, about 0.8% to about 5.0%, about 0.8% to about 4.5%, about 0.8% to about 4.0%, about 0.8% to about 3.5%, about 0.8% to about 3.0%, about 0.8% to about 2.5%, about 1.0% to 7.0%, about 1.0% to about 6.5%, about 1.0% to about 6.0%, about 1.0% to about 5.5%, about 1.0% to about 5.0%, about 1.0% to about 4.5%, about 1.0% to about 4.0%, about 1.0% to about 3.5%, about 1.0% to about 3.0%, about 1.0% to about 2.75%, about 1.0% about 2.5%, and about 1.0% to about 2.0% by weight in a coating. Other ranges are also contemplated.

In many embodiments, the coating comprising at least one salicylate with at least 10 carbon atoms further comprises at least one: thickener, defoamer, surfactant, dispersant, matting agent, solvent, antimicrobial agent, pigment, hardener, resin, light stabilizer, plasticizer, antioxidant, catalyst, flow aid, anti-corrosive agent, adhesion promotor, toughening agent, or combinations thereof. Additionally, other additives may be appropriate for the desired use or application of the coating comprising at least one salicylate with at least 10 carbon atoms to promote various properties. Examples include, but are not limited to, other polymers or polymer dispersions, biocides, mildewcides, algaecides, leveling agents, anti-settling agents, pH buffers, corrosion inhibitors, driers, anti-skinning agents, anti-cratering agents, anti-sag agents, heat stabilizers, UV absorbers/inhibitors, HALS (hindered amine light stabilizers), antioxidants, wetting agents, flatteners and other inert pigments (such as titanium dioxide, dyes, clay, amorphous and surface treated silica, calcium carbonate, and the like, and combinations thereof), flow agents, catalysts, flow aids, anti-corrosive agents, adhesion promotors, toughening agents, and the like, and various combinations thereof as needed for a particular application. Other additives are also contemplated.

In some embodiments, at least one salicylate may act as a plasticizer in the coating described herein. In many embodiments, at least one salicylate may be non-reactive in the coating described herein.

In many embodiments, the coating comprising at least one salicylate with at least 10 carbon atoms further comprises at least one resin. In some embodiments, the coating comprising at least one salicylate with at least 10 carbon atoms further comprises at least one polyurethane, polyurea, polyaspartic, MA, (meth)acrylic, alkyd, melamine, polyester, nitrocellulose, or combinations thereof. In one embodiment, the (meth)acrylic is a 1K acrylic. Other resins are also contemplated.

In many embodiments, the coating described herein comprising at least one salicylate with at least 10 carbon atoms is at least partially coated onto a substrate and wherein the substrate comprises wood, metal, glass, plastic, paper, leather, fabric, ceramic, composites, or combinations thereof. Other substrates are also contemplated.

In many embodiments, a measured ASTM D2369 solids of the coating described herein comprising at least one salicylate with at least 10 carbon atoms is greater than an unmodified coating without at least one salicylate comprising at least 10 carbon atoms. In some embodiments, the coating described herein may comprise increased solids over unmodified coatings without salicylates in order to maintain performance and application properties.

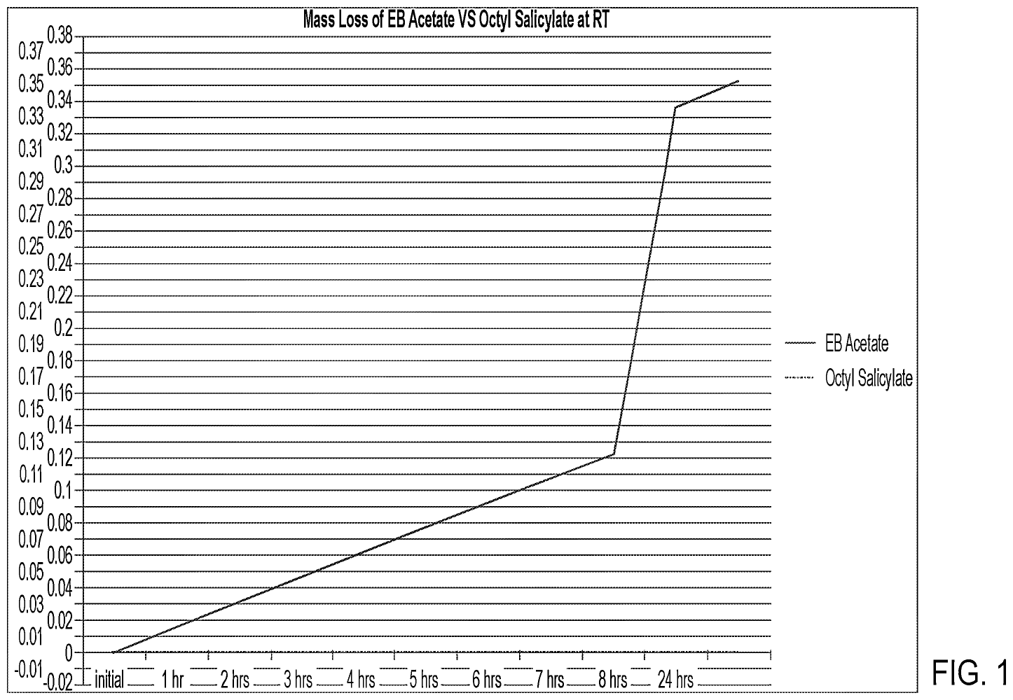

As provided in FIG. 1, mass loss testing was completed at room temperature (RT) of 25° C. Based on the testing, the mass loss of a coating containing ethylene glycol monobutyl ether acetate (EB acetate) is greater than a coating described herein comprising octyl salicylate. Specifically, the quantity of non-volatile matter (NVM using ASTM D2832) remains constant for a coating described herein comprising octyl salicylate but changes over time for a coating containing ethylene glycol monobutyl ether acetate (EB acetate). In other words, the salicylate is retained in the coating during normal solids assessments.

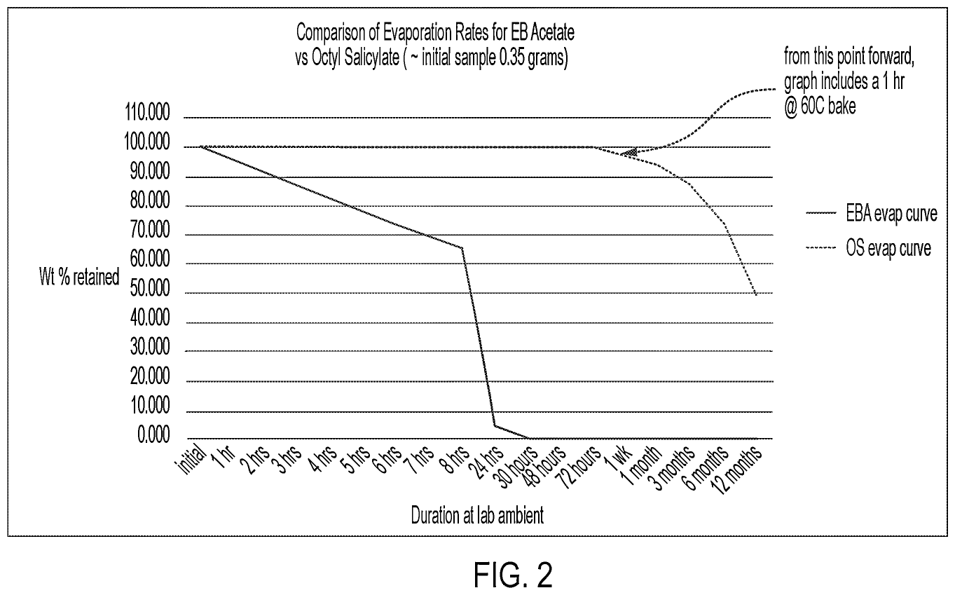

Additionally in FIG. 2, the evaporation rates for a coating containing ethylene glycol monobutyl ether acetate (EB acetate) were compared to a coating described herein comprising octyl salicylate. As tested using a vapor pressure at 25° C., the coating containing ethylene glycol monobutyl ether acetate (EB acetate) evaporated considerably faster over time than the coating described herein comprising octyl salicylate.

Also described herein is a method of preparing the coating described herein comprising at least one salicylate comprising at least 10 carbon atoms. In many embodiments, at least one salicylate may be incorporated during the production of the coating. In some embodiments, at least one salicylate may be incorporated into at least one material used to prepare the coating. In yet other embodiments, at least one salicylate may be post-added to a coating.

In one embodiment, an article may comprise: 1) a substrate having at least one surface; and 2) the coating described herein and comprising at least one salicylate comprising at least 10 carbon atoms is at least partially coated on the at least one substrate. In many embodiments, the substrate comprises wood, metal, glass, plastic, paper, leather, fabric, ceramic, composites, or any combination thereof. Other substrates are also contemplated.

In another embodiment, an article may comprise: 1) a substrate having at least one surface; 2) at least one additional coating at least partially coated on the at least one surface; and 3) the coating described herein and comprising at least one salicylate with at least 10 carbon atoms at least partially coated on the at least one additional coating. In many embodiments, the substrate comprises wood, metal, glass, plastic, paper, leather, fabric, ceramic, composites, or any combination thereof. Other substrates are also contemplated. In many embodiments, at least one additional coating may comprise a solvent borne or a waterborne coating. In one embodiment, at least one additional may be different from the coating comprising at least one salicylate with at least 10 carbon atoms described herein. In another embodiment, at least one additional coating may be the same as the coating comprising at least one salicylate with at least 10 carbon atoms described herein.

### EMBODIMENTS

The following embodiments are contemplated. All combinations of features and embodiments are contemplated.

Embodiment 1: A coating comprising at least one salicylate with at least 10 carbon atoms.

Embodiment 2: An embodiment of Embodiment 1, wherein the coating is a paint, stain, varnish, clearcoat, lacquer, drying oil, or powder.

Embodiment 3: An embodiment of Embodiment 1, wherein the coating is a surface treatment, primer, intermediate coat, or topcoat.

Embodiment 4: An embodiment of any of Embodiments 1-3, wherein the coating is solvent borne.

Embodiment 5: An embodiment of any of Embodiments 1-4, wherein at least one salicylate comprises benzyl salicylate, octyl salicylate (2-ethyl hexyl salicylate), heptyl salicylate, hexyl salicylate, amyl salicylate, iso amyl salicylate, iso butyl salicylate, methyl salicylate, ethyl salicylate, or combinations thereof.

Embodiment 6: An embodiment of any of Embodiments 1-5 further comprising at least one polyurethane, polyurea, polyaspartic, MA, 1K acrylic, alkyd, melamine, polyester, nitrocellulose, or combinations thereof.

Embodiment 7: An embodiment of any of Embodiments 1-6, wherein the coating comprises 0.5% to 7.0% by weight of at least one salicylate with at least 10 carbon atoms.

Embodiment 8: An embodiment of any of Embodiments 1-6, wherein the coating comprises 0.7% to 4.0% by weight of at least one salicylate with at least 10 carbon atoms.

Embodiment 9: An embodiment of any of Embodiments 1-8 further comprising at least one: thickener, defoamer, surfactant, dispersant, matting agent, solvent, antimicrobial agent, pigment, hardener, resin, light stabilizer, plasticizer, antioxidant, catalyst, flow aid, anti-corrosive agent, adhesion promotor, toughening agent, or combinations thereof.

Embodiment 10: An embodiment of any of Embodiments 1-9, wherein the coating is at least partially coated onto a substrate and wherein the substrate comprises wood, metal, glass, plastic, paper, leather, fabric, ceramic, composites, or combinations thereof.

Embodiment 11: An embodiment of any of Embodiments 1-9, wherein the coating is at least partially coated onto a base coat.

Embodiment 12: An embodiment of any of Embodiments 1-11, wherein an evaporation rate is less than the threshold of a solid as defined by EPA.

Embodiment 13: An embodiment of any of Embodiments 1-12, wherein a measured ASTM D2369 solids of the coating is greater than an unmodified coating without at least one salicylate comprising at least 10 carbon atoms.

Embodiment 14: A method of preparing a coating comprising the steps of: preparing the coating of Embodiments 1-13.

Embodiment 15: An article comprising: 1) a substrate having at least one surface; and 2) the coating of any of Embodiments 1-13 at least partially coated on the at least one substrate; wherein the substrate comprises wood, metal, glass, plastic, paper, leather, fabric, ceramic, composites, or any combination thereof.

Embodiment 16: An article comprising: 1) a substrate having at least one surface; 2) at least one additional coating at least partially coated on the at least one surface; and 3) the coating of any of Embodiments 1-13 at least partially coated on the at least one additional coating; wherein the substrate comprises wood, metal, glass, plastic, paper, leather, fabric, ceramic, composites, or any combination thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A coating comprising at least one salicylate with at least 10 carbon atoms.

2. The coating of claim 1, wherein the coating is a paint, stain, varnish, clearcoat, lacquer, drying oil, or powder.

3. The coating of claim 1, wherein the coating is a surface treatment, primer, intermediate coat, or topcoat.

4. The coating of claim 1, wherein the coating is solvent borne.

5. The coating of claim 1, wherein at least one salicylate comprises benzyl salicylate, octyl salicylate (2-ethyl hexyl salicylate), heptyl salicylate, hexyl salicylate, amyl salicylate, iso amyl salicylate, iso butyl salicylate, methyl salicylate, ethyl salicylate, #or combinations thereof.

6. The coating of claim 1 further comprising at least one polyurethane, polyurea, polyaspartic, MA, acrylic, alkyd, melamine, polyester, nitrocellulose, or combinations thereof.

7. The coating of claim 1, wherein the coating comprises 0.5% to 7.0% by weight of at least one salicylate with at least 10 carbon atoms.

8. The coating of claim 1, wherein the coating comprises 0.7% to 4.0% by weight of at least one salicylate with at least 10 carbon atoms.

9. The coating of claim 1 further comprising at least one: thickener, defoamer, surfactant, dispersant, matting agent, solvent, antimicrobial agent, pigment, hardener, resin, light stabilizer, plasticizer, antioxidant, catalyst, flow aid, anti-corrosive agent, adhesion promotor, toughening agent, #or combinations thereof.

10. The coating of claim 1, wherein the coating is at least partially coated onto a substrate and wherein the substrate comprises wood, metal, glass, plastic, paper, leather, fabric, ceramic, composites, or combinations thereof.

11. The coating of claim 1, wherein the coating is at least partially coated onto a base coat.

12. The coating of claim 1, wherein an evaporation rate is less than the threshold of a solid as defined by EPA.

13. The coating of claim 1, wherein a measured ASTM D2369 solids of the coating is greater than an unmodified coating without at least one salicylate comprising at least 10 carbon atoms.

14. A method of preparing a coating comprising the steps of:
preparing the coating of claim 1.

15. An article comprising:
a substrate having at least one surface; and
the coating of claim 1 at least partially coated on the at least one substrate;
wherein the substrate comprises wood, metal, glass, plastic, paper, leather, fabric, ceramic, composites, or any combination thereof.

16. An article comprising:
a substrate having at least one surface;
at least one additional coating at least partially coated on the at least one surface; and
the coating of any of claim 1 at least partially coated on the at least one additional coating;
wherein the substrate comprises wood, metal, glass, plastic, paper, leather, fabric, ceramic, composites, or any combination thereof.
